(19) United States
(12) Patent Application Publication
(10) Pub. No.: US 2006/0104863 A1
(43) Pub. Date: May 18, 2006

(54) Sample preparation system for a laboratory apparatus

(76) Inventor: Michael L. Bell, Fullerton, CA (US)

Correspondence Address: THE LAW OFFICES OF ROBERT B. POLIT, 8804 LAKE RIDGE DR., DARIEN, IL, 60561, US

(21) Appl. No.: 10/986,705

(22) Filed: Nov. 12, 2004

(51) Int. Cl. G01N 1/00

(52) U.S. Cl. 422/72; 422/103; 422/64

(57) ABSTRACT

A laboratory apparatus that is readily adapted to execute a wide range of sample preparation protocols is a set forth. The laboratory apparatus comprises a plurality of tools that are adapted to execute one or more processes in preparing a sample for subsequent analysis and a hollow rotor that is mounted for rotation about a rotation axis. A septum divides the hollow rotor into first and second chambers. Both the first and second chambers are accessible to one or more of the plurality of tools. One or more valve mechanisms are disposed to control fluid communication between the first and second chambers based, at least in part, on the rotation rate imparted to the hollow rotor.

### FIELD OF THE INVENTION

The present invention is generally directed to apparatus used to analyze or otherwise manipulate a chemical and/or biological material. More particularly, the present invention is directed to a flexible sample preparation system for laboratory apparatus.

### BACKGROUND OF THE INVENTION

The manipulation of chemical and/or biological materials in a laboratory environment is often quite labor-intensive. Recent trends in laboratory equipment design therefore point toward greater automation of many of these manipulation steps. Among other things, automation increases the throughput of the analyses executed by the equipment, reduces the costs of manual labor in the laboratory, increases the reliability of the analyses and protects laboratory workers from undesired contact with hazardous chemical and/or biological materials.

Preparation of a sample for subsequent analysis is one area that has not been easily susceptible to automation. Often, sample preparation involves a complex series of steps that must be executed manually by skilled technicians. Unfortunately, even the most skilled technicians may have difficulty executing these steps accurately and in a manner that insures consistency between tests performed on different samples of the same type. Such problems become particularly evident win the sample preparation protocol must be applied to a large number of samples.

A laboratory instrument including several mechanisms used in the preparation of a sample for subsequent analysis is set forth in U.S. Pat. No. 5,296,195, entitled “Automatic Immunochemistry Analyzing Apparatus and Method”, issued Mar. 22, 1994, to Pang et al. In operation, a sample diluter/dispenser is disposed on a carriage assembly for movements between a plurality of processing stations. The sample diluter/dispenser is first moved to a position juxtaposed a sample container where an amount of diluent is automatically dispensed in a precise amount to dilute the sample. A precise amount of the diluted sample is then automatically remove from the container by the sample diluter/dispenser. The sample diluter/dispenser is then moved to a position juxtaposed a reaction cuvette where the sample is dispensed for reaction with a reagent. One or more parameters of the reaction are monitored to obtain an analysis of the sample.

Although the foregoing apparatus represents a significant step toward automating sample preparation protocols, its flexibility is somewhat limited. As such, a significant number of manually executed preparation steps are still required to implement a variety of sample preparation protocols.

### SUMMARY OF THE INVENTION

A laboratory apparatus that is readily adapted to execute a wide range of sample preparation protocols is a set forth. The laboratory apparatus comprises a plurality of tools that are adapted to execute one or more processes in preparing a sample for subsequent analysis and a hollow rotor that is mounted for rotation about a rotation axis. A septum divides the hollow rotor into first and second chambers. Both the first and second chambers are accessible to one or more of the plurality of tools. One or more valve mechanisms are disposed to control fluid communication between the first and second chambers based, at least in part, on the rotation rate imparted to the hollow rotor.

In accordance with one embodiment of the laboratory apparatus, the septum divides the hollow rotor into an upper chamber and a lower chamber. The septum also includes a central opening. A dam wall is disposed in the upper chamber radially at a position exterior to and circumventing the central opening of the septum. A valve mechanism is disposed to control the exit of fluids from the upper chamber to an area exterior the hollow rotor. A spin-activated siphon path provides controlled fluid communication between the lower chamber and an area of the upper chamber radially exterior of the dam wall based on rotation rate of the hollow rotor.

### BRIEF DESCRIPTION OF THE DRAWINGS

FIG. 1 is a schematic block diagram and cross-sectional view of one embodiment of a flexible sample preparation apparatus of the present invention.

FIG. 2 is a cross-sectional view of the hollow rotor of FIG. 1 showing a pipette tool accessing the lower chamber.

FIG. 3 is a cross-sectional view of the hollow rotor of FIG. 1 showing a homogenizer tool accessing the axial depression in the lower chamber.

FIG. 4 is a cross-sectional view of the hollow rotor of FIG. 1 showing a pipette tool accessing the upper chamber.

### DESCRIPTION OF A PREFERRED EMBODIMENT OF THE INVENTION

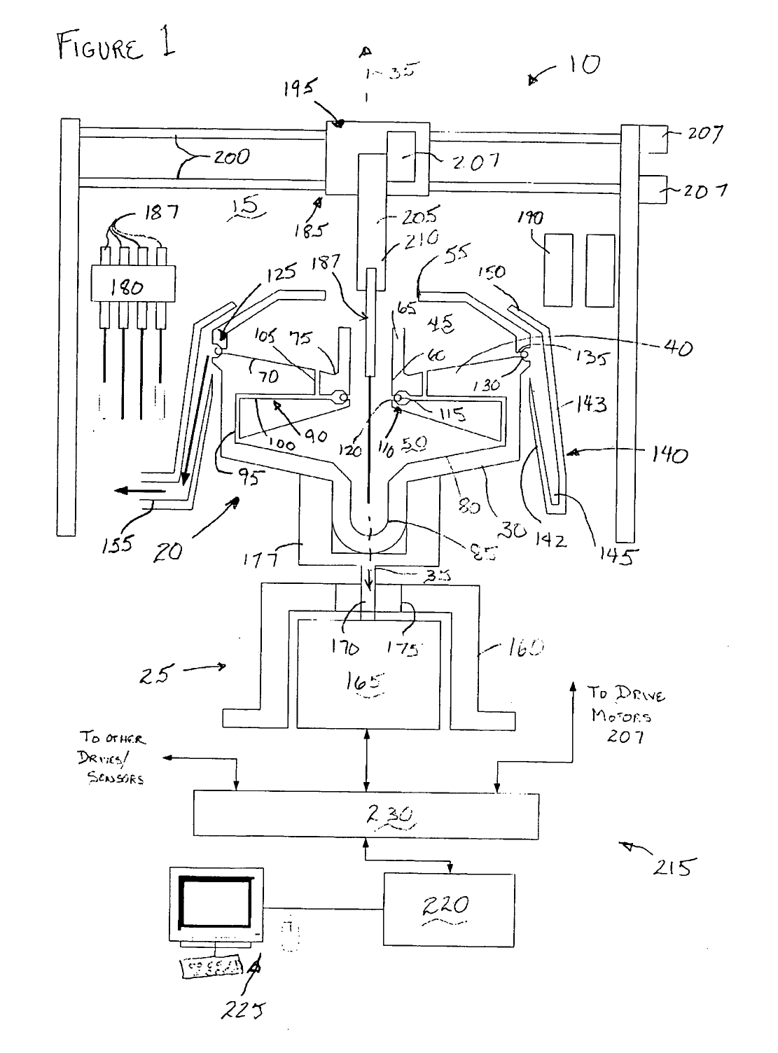

One embodiment of a sample preparation system suitable for use in automatically executing a wide range of sample preparation protocols is shown generally at 10 of FIG. 1. Generally stated, sample preparation system 10 includes a tool system 15, hollow rotor system 20 and a rotor system drive 25.

Hollow rotor system 20 includes a hollow rotor, shown generally at 30, that is mounted on the rotor system drive 25 for rotation about axis 35. A septum 40 divides the interior portion of hollow rotor 30 into at least two chambers. In the illustrated embodiment, septum 40 is oriented horizontally within hollow rotor 30 to divide the interior portion into an upper chamber 45 and a lower chamber 50. However, it will be recognized that other embodiments of the hollow rotor system 20 may have septum 40 oriented within hollow rotor 30 to divide the interior into concentric chambers. Preferably, the volumetric capacity of the upper chamber 45 exceeds the volumetric capacity of the lower chamber 50.

Hollow rotor 30 includes at least one aperture 55 through which processing tools of tool system 15 can gain access into the interior of hollow rotor 30. In the illustrated embodiment, a single aperture 55 is disposed through a top wall of the hollow rotor 30 and is concentric with rotation axis 35. Septum 40 includes a central opening 60 therethrough that is likewise concentric with rotation axis 35. A dam wall 65 proceeds upward from the slanted floor 70 of upper chamber 45 and circumvents central opening 60. This forms a fluid well 75 in upper chamber 45 in the region of the chamber that is radially exterior to the dam wall 65. The floor 80 of the lower chamber 50 is likewise slanted in the direction of rotation axis 35. An axial depression 85 is provided in floor 80 and is shaped to conform to the profile of one or more tools of tool system 15, such as a tissue homogenizer. Aperture 55 is constructed so that it is large enough to allow tool access to both the fluid well 75 of upper chamber 45 and to the axial depression 85 of lower chamber 50.

Fluid communication between the lower chamber 50 and upper chamber 45 is controlled, at least in part, by a spin-activated siphon path, shown generally at 90, that connects the outer radius of the lower chamber 50 to a point near the inner radius of the upper chamber 45 through septum 40. In the illustrated embodiment, the spin-activated siphon path 90 includes a generally vertical siphon channel 95 and a generally horizontal siphon channel 100. Channel 95 is disposed at an interior wall of the lower chamber 50 and has a first end that is open to the outer radial portion of lower chamber 50. Channel 100, in turn, has a first end in fluid communication with channel 95 and a second end that terminates proximate the central opening 60 of septum 40. A further generally vertical siphon channel 105 proceeds through septum 40 and places the second end of channel 100 in fluid communication with a region of the upper chamber 45 that is radially exterior to dam wall 65.

A spin-activated valve 110 is located proximate the second end of channel 100. Spin-activated valve 110 includes a compliant ring 115 that seals a set of holes 120 that open to central opening 60 when the hollow rotor is at rest. As hollow rotor 30 rotates about axis 35, the compliant ring 115 expands in a direction away from axis 35 and opens the set of holes 120. One embodiment of such a spin-activated valve is set forth in U.S. Pat. No. 5,935,051, entitled “Blood Separation Device” and issued on Aug. 10, 1999, to Bell.

When hollow rotor 30 is rotated at a rate at which the holes 120 remain sealed by compliant ring 115 and the fluid level in the lower chamber 50 passes radially inward of channel 105, a siphoning action ensues that transfers the entire contents of lower chamber 50 into upper chamber 45.

When hollow rotor 30 is rotated at a rate at which compliant ring 115 no longer seals holes 120, the siphon action is broken, and the siphon channel acts as a simple weir. Only the quantity of fluid in excess of that required to fill the lower chamber 50 beyond the upper level of channel 105 transfers to upper chamber 45.

The siphon action may be interrupted during the fluid transfer process by increasing the rotation rate to expand the ring 115 mid-stream to thereby effect only a partial transfer of fluid from the lower chamber 50 to the upper chamber 45.

If, while hollow chamber 30 is spinning, the fill level of upper chamber 45 exceeds the fill level of lower chamber 50, and the fill level of upper chamber 45 exceeds the level of channel 105, then fluid flows from upper chamber 45 to lower chamber 50 through channels 105, 100, and 95 until either the fluid levels in upper and lower chambers are equal or the fluid level in upper chamber 45 passes the level of channel 105.

When rotation is stopped and upper chamber 45 contains fluid, the contents of upper chamber 45 flow to dam wall 65 and overlie the upper opening of vertical siphon channel 105. Channel 105 is sized such that surface tension prevents drainage of upper chamber 45 when the driving force is gravity. This surface tension is overcome during other transfer steps because the rotation provides a stronger driving force.

A further spin-activated valve 125 is disposed in a peripheral wall of upper chamber 45. Spin-activated valve 125 likewise includes a compliant ring 130 that is disposed to normally seal a plurality of holes 135. When hollow rotor 30 is rotated at a rate that is sufficient to unseal holes 135, fluid in upper chamber 45 exits through holes 135 into a fluid collector 140 due to the centrifugal force imposed on the rotor contents. Preferably, spin-activated valve 125 is constructed to unseal holes 135 at a higher rotation rate than the rate at which spin-activated valve 110 unseals holes 120. The rotation rate at which a valve activates may be controlled by varying the size, the hardness and the amount of pre-stretch applied to the rings 115 and 130.

As shown, fluid collector 140 is disposed about the periphery of hollow rotor 30 to collect fluid exiting holes 135. To this end, fluid collector 140 includes an interior sidewall 142 and an exterior sidewall 143 that define a well 145. Well 145 is bounded at its upper portion by a lip 150 that extends radially inward over an upper peripheral portion of the hollow rotor 30. Fluid exiting holes 135 is flung against exterior sidewall 143 and collects in well 145. Lip 150 assists in constraining the splatter of the fluid that contacts sidewall 143 to the fluid collector 140. Well 145 is in fluid communication with an outlet 155 through which the content of the fluid collector 140 exits the hollow rotor system 20.

A still further spin-activated exhaust valve (not illustrated) may be disposed in the peripheral wall of the lower chamber 50. If included, this valve would preferably be designed to activate at a rotation rate that is higher than the rotation rate at which spin-activated valve 125 opens. Its presence would permit simpler wash and exhaust of unwanted high density material directly from the lower chamber 50. In such instances, the upper portion of interior sidewall 142 of fluid collector 140 would be lowered to thereby expose exterior sidewall 143 to fluid exiting the spin-activated valve of the lower chamber 50.

Rotor system drive 25 includes a base member 160 that houses a rotary drive motor 165. Rotary drive motor 165 includes a drive shaft 170 that extends through an aperture 175 disposed through base member 160. Drive shaft 170 extends from rotary drive motor 165 to engage a coupling assembly 177 that connects the drive shaft 170 to the hollow rotor 30 of the hollow rotor system 20.

In the illustrated embodiment, tool system 15 includes a tool rack 180 and an automated tool drive 185. Tool rack 180 is adapted to support the operative portions 187 of a plurality of tools that are adapted to execute one or more processes in a sample preparation protocol. Automated tool drive 185, in turn, is adapted to selectively engage each of the operative portions 187 and bring it to a position juxtaposed hollow rotor system 20. Tool drive 185 further moves the operative portion 187 of the tool into engagement with the hollow rotor system 20 for execution of the desired processing step in the overall protocol. After the desired processing step is completed, tool drive 35 may move the operative portion 187, for example, to a wash station 190 where it may be cleaned for use in subsequent operations.

Automated tool drive 185 may include a carriage assembly 195 disposed for horizontal movement along a plurality of guide rods 200 and a sub-carriage assembly 205 disposed for vertical movement on the carriage assembly 195. A plurality of drives, shown at 207, are provided to impart horizontal motion to the carriage assembly 195 and vertical motion to the sub-carriage assembly 205 at the desired times and to the desired degrees. Sub-carriage assembly 205 includes an end portion 210 that is adapted to selectively engage the operative portions 187 of the tools supported on tool rack 180. Other mechanisms (pumps, syringes, motor drives, electrical connections, pneumatic connections, etc.) needed to support the operative portions 187 of the tools may also be carried by either or both the carriage assembly 195 and sub-carriage assembly 205.

It will be recognized that tool system 15 can be implemented in a variety of different manners. For example, although the illustrated embodiment only employs a single carriage assembly 195 and sub-carriage assembly 205, automated tool drive 185 can likewise be implemented with multiple carriage assemblies/sub-carriage assemblies. One manner of implementing such a multiple carriage/sub-carriage system is illustrated in the '195 patent discussed above. A further manner of implementing a multiple carriage/sub-carriage system is set forth in U.S. Ser. No. ______, entitled “APPARATUS HAVING IMPROVED GANTRY ASSEMBLY SUITABLE FOR USE IN A LABORATORY ENVIRONMENT”, filed Oct. 22, 2004 (Attorney Docket Number 6420P0060US; Client File 03ID7023), the teachings of which are hereby incorporated by reference.

Tool system 15 can also be implemented as an integrated assembly disposed on a rotating tool rack positioned above the hollow rotor system 20. In such a system, the tools needed to implement the sample preparation protocol are sequentially rotated to a position juxtaposed hollow rotor system 20 before being driven into engagement therewith. In a further embodiment, a rotating tool rack may be disposed on each of a plurality of carriage/sub-carriage assemblies of the type described above.

Tool system 15 may include a variety of processing tools to make it capable of executing a wide range of sample preparation protocols. For example, tool system 15 may include a homogenizer, a blender blade, a pipette probe, a mixer, an aspirator, a fluid dispenser, a hollow fiber filtration cartridge, a dry reagent transfer device, etc. Operative portions 187 of these tools may be supported by tool rack 180 for access by automated tool drive 185. Alternatively, complete tools may be independently carried by individual carriage/sub-carriage assemblies and/or by a rotating tool rack.

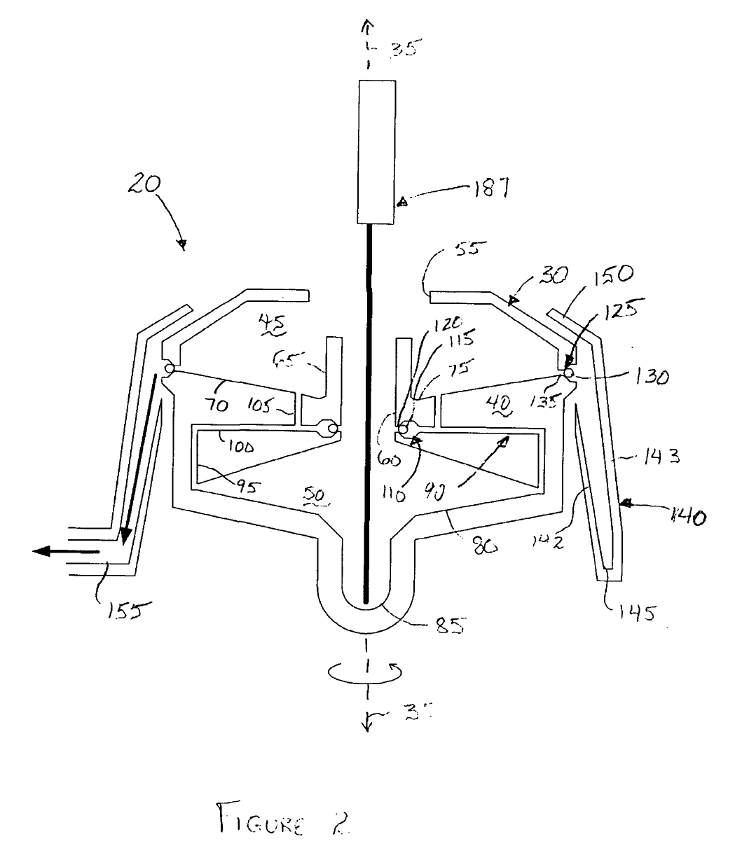

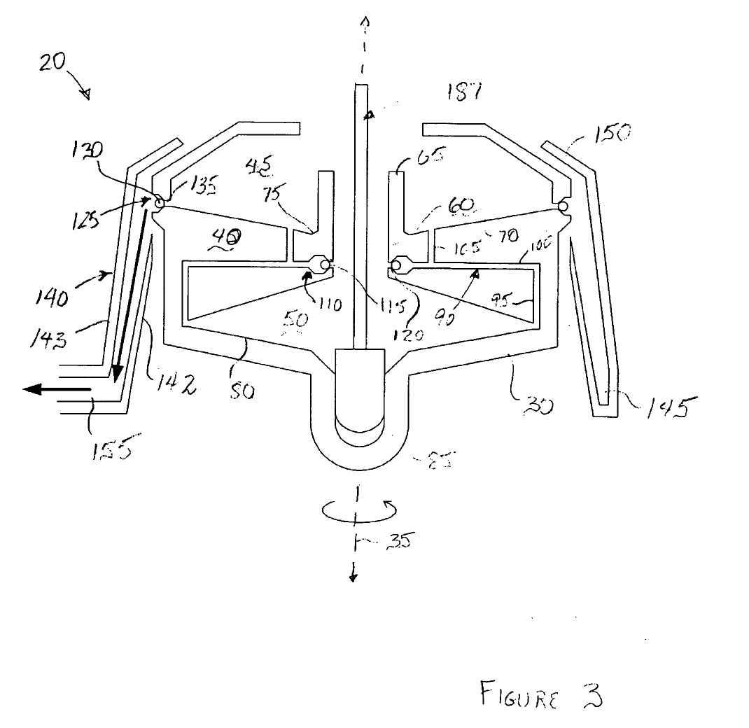

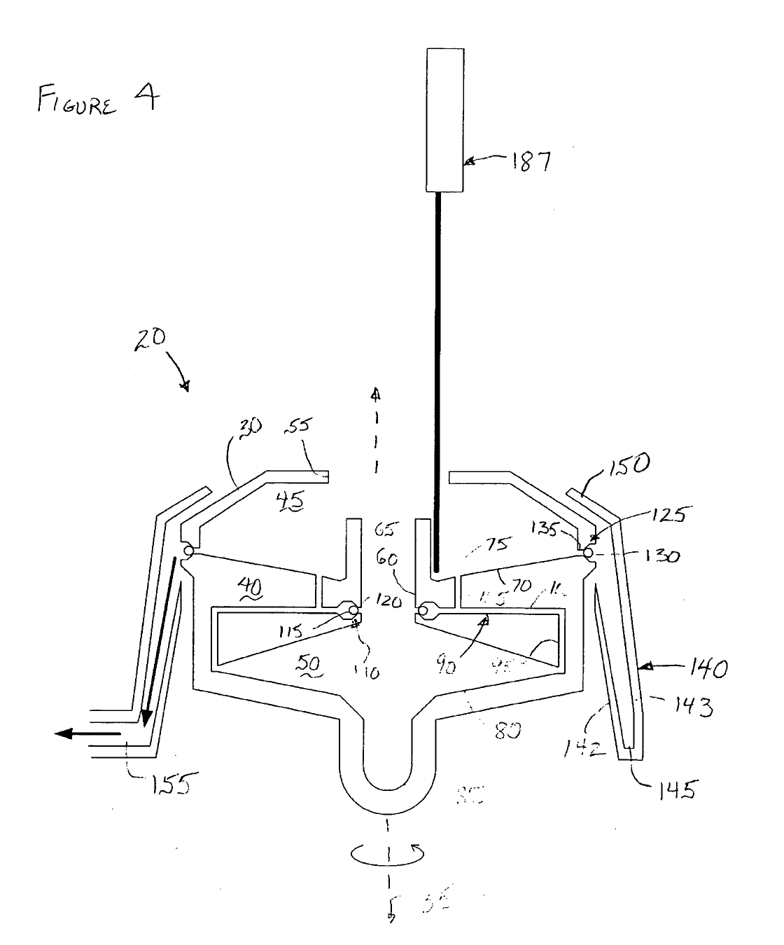

The tools of tool system 15 may have multiple operating alignments or elevations with respect to the hollow rotor 30. For example, a pipetting probe aligns with the center of the hollow rotor 30 at the elevation of the bottom of axial depression 85 to aspirate a sample from the lower chamber 50. This relative alignment is illustrated in FIG. 2. Similarly, a homogenizer tool may be aligned with the center of the hollow rotor 30 at an elevation that places it within axial depression 85, which is adapted to conform to the shape of the homogenizer tool. This relative alignment is illustrated in FIG. 3. A pipetting probe aligns off-center at a higher elevation to aspirate a sample from behind the dam wall 65 of upper chamber 45. This relative alignment is illustrated in FIG. 4.

Operation and synchronization of the foregoing system components is preferably achieved by interfacing the components with a programmable control system, shown generally at 215. Programmable control system 215 may include a central processor 220, a user interface 225 and one or more slave processors/processor interface units 230. Central processor 220 includes the programming required to execute the desired sample preparation protocol. The sample preparation protocol may be entered through user interface 225. User interface 225 may include a keyboard, monitor, mouse, touchscreen, etc., or any other components that allow a human operator to interact with the other portions of the sample preparation system 10 through central processor 220. Slave processors/processor interface units 230 include the components necessary to interface the programming executed by central processor 220 with the system hardware components. Such system hardware components include motors 207, rotary drive motor 165, pumps, hydraulics, pneumatics, etc.

Sample preparation system 10 can be programmed to execute a wide range of sample preparation actions. Examples of these actions include the following:
Adding a sample to the lower chamber 50;
Adding a reagent to the lower chamber 50;
Adding a sample to the upper chamber 45:
Adding a reagent to the upper chamber 45;
Transferring the contents of the hollow rotor 30 from the lower chamber 50 to the upper chamber 45;
Transferring an aliquot from the lower chamber 50 to the upper chamber 45;
Transferring an aliquot from the upper chamber 45 to the lower chamber 50;
Emptying the lower chamber 50;
Emptying the upper chamber 45;
Rinsing the upper chamber 45;
Rinsing the lower chamber 50;
Setting the rotation rate for the hollow rotor 30;
Positioning a processing tool at the proper horizontal position for access to either the upper chamber 45 or lower chamber 50;
Placing the processing tool at the proper vertical elevation with respect to either the upper chamber 45 or lower chamber 50;
Activating the processing tool.

Most of the foregoing actions require a sequence of individual motions. Exemplary motions for some of the foregoing actions are set forth below.

ACTION: Adding a Reagent to the Lower Chamber 50
Position pipette above a reagent bottle
Aspirate separator air bubble
Lower pipette into reagent with level sense and extract a measured amount of reagent from bottle
Raise pipette from reagent bottle
Position pipette at pipette washer
Wash pipette exterior
Position pipette above center of hollow rotor 30
Lower pipette into axial depression 85
Dispense reagent into axial depression 85
Raise pipette from hollow rotor 30
Position pipette at pipette washer
Wash pipette interior and exterior

ACTION: Transfer Contents from Lower Chamber 50 to Upper Chamber 45
Set rotation rate of hollow rotor so that all spin-activated valves are closed
Position fluid dispenser above center of hollow rotor 30
Lower fluid dispenser into lower chamber 50
Dispense fluid until fluid reaches channel 105

ACTION: Drain and Rinse Lower Chamber 50 Leaving Contents of Upper Chamber 45 Unaffected
Stop rotation of hollow rotor 30
Position rinsing fluid dispenser above center of hollow rotor 30
Lower rinsing fluid dispenser into lower chamber 50
Dispense rinsing fluid into lower chamber 50
Optionally, mix rinsing fluid in lower chamber 50 (on-the-fly or with mixing paddle)
Remove rinsing fluid dispenser from lower chamber 50
Position an aspirator tool above center of hollow rotor 30 and lower therein
Drain rinsing fluid from lower chamber 50 through aspirator tool

ACTION: Transfer Aliquot from Upper Chamber 45 to Lower Chamber 50
Stop rotation of hollow rotor 30
Position pipette at rotor 30 for access to upper chamber 45 (off-center)
Aspirate separator air bubble
Lower pipette radially outward of dam wall 65 in upper chamber 45
Aspirate aliquot
Position pipette at rotor 30 for access to lower chamber 50
Lower pipette into lower chamber 50
Dispense aliquot
Raise pipette from hollow rotor 30
Position pipette at pipette washer
Wash pipette interior and exterior

ACTION: Simple Mix in Lower Chamber 50
Position mix paddle above center of hollow rotor 30
Lower mix paddle into axial depression 85
Spin hollow rotor 30 at low rotation rate
Raise mix paddle from hollow rotor 30
Position mix paddle at paddle washer
Wash mix paddle

ACTION: On-the-Fly Mixing (Both Chambers)
Spin hollow rotor 30
Apply low-amplitude sinusoidal velocity profile onto constant rotor velocity

The foregoing processing actions can be combined in various manners to execute a substantial range of different sample processing protocols. A first example of one such sample preparation protocol is the isolation of monocytes from anti-coagulated whole blood. This discontinuous density gradient separation is based on the method disclosed by de Almeida and includes the following sample preparation steps:
Add Ficol Hypaque (density 1.070) to the lower chamber 50
Spin the hollow rotor 30 at a low rotation rate
Slowly add anti-coagulated blood to the lower chamber 50
Spin the hollow rotor 30 at a rotation rate that is sufficient to sediment the cells
With hollow rotor 30 spinning at a rate that opens spin-activated valve 110, add Isoton to lower chamber 50 to displace heavier cells to upper chamber 45
Drain and rinse the upper chamber 45
Add hyperosmotic Percoll (density 1.064) to the upper chamber 45
With hollow rotor 30 spinning at a rate at which spin-activated valve 110 is closed, add Isoton to transfer the contents of lower chamber 50 to the upper chamber 45
Drain and rinse the lower chamber 50 (stop rotation and aspirate)
Spin the hollow rotor 30 at a rotation rate that is sufficient to sediment the cells
Add an additional amount of Percoll to transfer unwanted cells and serum to the lower chamber 50
Stop rotation of the hollow rotor 30
Aspirate monocytes from the upper chamber 45
Drain and rinse the lower chamber 50
Drain and rinse the upper chamber 45

A second example of a sample preparation protocol that may be implemented in system 10 is the isolation of washed cells from explants of mouse mammary adenocarcinoma. This protocol may include the following sample preparation steps:
Load a tissue sample into the axial depression 85 of the lower chamber 50
Add Isoton to the lower chamber 50
Position, lower and activate a blender blade tool into the axial depression 85 while rotating hollow rotor 30 to coarsely chop the sample
Position, lower and activate a homogenizer tool into the axial depression 85 while rotating hollow rotor 30 to finely divide the sample
Add cold Isoton
Spin the hollow rotor 30 at a rotation rate that is sufficient to sediment the cells
With the hollow rotor 30 spinning at a rotation rate that is sufficient to open spin-activated valve 110, add Isoton to transfer the cells from the lower chamber 50 to the upper chamber 45
Aspirate cells from the upper chamber 45
Drain and rinse debris from lower chamber 50
Drain and rinse upper chamber 45

A third example of a sample preparation protocols that may be implemented in system 10 is the extraction of glycated hemoglobin from anti-coagulated whole blood. Such a sample preparation protocol may include the following steps.
Dispense anti-coagulated blood sample into lower chamber 50
Spin the hollow rotor 30 at a rate sufficient to sediment the cells
With the hollow rotor 30 spinning at a rate at which valve 110 remains closed, add a sufficient amount of Isoton to transfer cells from the lower chamber 50 to the upper chamber 45
Increase the rotation rate of the hollow rotor 30 during cell transfer at a predetermined time to prevent the transfer of plasma from the lower chamber 50 to the upper chamber 45
Drain the lower chamber 50
Add hypotonic saline with Brij 35 surfactant to the upper chamber 45 to lyse the red blood cells
Mix
Add aminophenylboronate agarose beads to the upper chamber 45 to absorb glycoproteins
Mix
Spin the hollow rotor 30 to sediment the beads
Add rinse to upper chamber 45 to displace unbound material to lower chamber 50
Stop rotation of hollow rotor 30
Aspirate collected product from lower chamber 50
Drain and rinse both the lower chamber 50 and upper chamber 45

As will be apparent, a substantial number of further sample preparation protocols may be executed using system 10. The foregoing protocols are merely exemplary and are provided to illustrate the versatility of system 10.

Numerous modifications may be made to the foregoing system without departing from the basic teachings thereof. Although the present invention has been described in substantial detail with reference to one or more specific embodiments, those of skill in the art will recognize that changes may be made thereto without departing from the scope and spirit of the invention as set forth in the appended claims.

What is claimed is:

1. A sample preparation system comprising:
a hollow rotor mounted for rotation about a rotation axis;
a septum dividing said hollow rotor into an upper chamber and a lower chamber, said septum having a central opening;
a dam wall disposed in said upper chamber radially exterior to and circumventing said central opening;
a valve mechanism disposed to control the exit of fluids from said upper chamber to an area exterior said hollow rotor;
a spin-activated siphon path providing controlled fluid communication between said lower chamber and an area of said upper chamber radially exterior of said dam wall based on rotation rate of said hollow rotor.

2. A sample preparation system as claimed in claim 1 wherein said septum defines a floor of said upper chamber that slants toward said dam wall.

3. A sample preparation system as claimed in claim 1 wherein said lower chamber comprises a floor that slants toward a central portion of said lower chamber.

4. A sample preparation system as claimed in claim 1 wherein said valve mechanism comprises a spin-activated valve disposed about said upper chamber.

5. A sample preparation system as claimed in claim 4 and further comprising a collection chamber disposed about an exterior portion of said upper chamber to receive fluid expelled through said spin-activated valve.

6. A sample preparation system as claimed in claim 1 and further comprising a collection chamber disposed about an exterior portion of said upper chamber to receive fluid expelled through said valve mechanism.

7. A sample preparation system as claimed in claim 1 wherein siphon action of said spin-activated siphon path is controlled by a spin-activated valve.

8. A sample preparation system as claimed in claim 7 wherein said valve mechanism comprises a spin-activated valve disposed about said upper chamber.

9. A sample preparation system as claimed in claim 8 wherein said spin-activated valve of said siphon path opens at a lower rotation rate compared to said spin-activated valve disposed about said upper chamber.

10. A sample preparation apparatus as claimed in claim 1 and further comprising one or more sample preparation tools adapted to access at least one of said upper chamber and said lower chamber through an opening in said hollow rotor.

11. A sample preparation apparatus as claimed in claim 10 wherein said one or more sample preparation tools comprises a tool selected from the group consisting of a homogenizer, a blender blade, a pipette probe, a mixer, an aspirator, a fluid dispenser, a hollow fiber filtration cartridge, and a dry reagent transfer device.

12. A sample preparation apparatus as claimed in claim 10 wherein said opening is disposed through a top of said hollow rotor.

13. A sample preparation apparatus as claimed in claim 12 wherein said opening is generally annular in shape and concentric with a spin axis of said hollow rotor.

14. A sample preparation apparatus as claimed in claim 13 wherein at least a portion of said opening overlies an area of said upper chamber peripherally exterior to said dam wall.

15. A sample preparation apparatus as claimed in claim 12 wherein said lower chamber includes a centrally disposed well in the floor thereof.

16. A sample preparation apparatus as claimed in claim 15 wherein said centrally disposed well is adapted to receive a homogenizer.

17. A sample preparation apparatus as claimed in claim 1 wherein said spin-activated siphon path comprises:
a generally vertical siphon channel disposed at an interior wall of said lower chamber, said generally vertically oriented siphon channel being open to said lower chamber at a lower end of said vertical siphon channel;
a generally horizontal siphon channel having a first end in fluid communication with said vertical siphon channel and a second end terminating proximate said central opening of said septum;
a spin-activated valve disposed proximate said second end of said horizontal siphon channel to control fluid flow between said second end and said central opening;
a further generally vertical siphon channel disposed through said septum to facilitate fluid communication between said generally horizontal siphon channel and said area of said upper chamber radially exterior said dam wall.

18. A laboratory apparatus comprising:
a plurality of tools adapted to execute one or more processes in preparing a sample for subsequent analysis;
a hollow rotor mounted for rotation about a rotation axis;
a septum dividing said hollow rotor into first and second chambers, said first and second chambers each being accessible to one or more of said plurality of tools;
one or more valve mechanisms disposed to control fluid communication between said first and second chambers based on rotation rate of said hollow rotor.

19. A laboratory apparatus as claimed in claim 18 wherein said plurality of tools comprises:
a tool rack supporting operative portions of said plurality of tools;
an automated tool drive adapted to engage operative portions of said plurality of tools from said tool rack and to place said operative portions into processing relationships with at least one of said first and second chambers.

20. A laboratory apparatus as claimed in claim 18 wherein said plurality of tools comprises:
one or more horizontally disposed guide rods;
at least one carriage assembly disposed for horizontal movement along said one or more guide rods;
a sub-carriage assembly disposed for vertical movement on at least one of said plurality of carriage assemblies, said sub-carriage assembly being adapted to carry an operative portion of at least one tool into a processing position with respect to at least one of said first and second chambers.

21. A laboratory apparatus as claimed in claim 20 and further comprising a tool changing station adapted to automatically change the operative portion of said at least one tool carried by said sub-carriage assembly.

22. A laboratory apparatus as claimed in claim 18 wherein said plurality of tools comprises a tool selected from the group consisting of a homogenizer, a blender blade, a pipette probe, a mixer, an aspirator, a fluid dispenser, a hollow fiber filtration cartridge, and a dry reagent transfer device.

23. A laboratory apparatus as claimed in claim 21 wherein said plurality of tools comprises a tool selected from the group consisting of a homogenizer, a blender blade, a pipette probe, a mixer, an aspirator, a fluid dispenser, a hollow fiber filtration cartridge, and a dry reagent transfer device.

24. A laboratory apparatus as claimed in claim 18 wherein said septum divides said hollow rotor into first and second concentric chambers.

25. A laboratory apparatus as claimed in claim 18 wherein said septum divides said hollow rotor into a first upper chamber and a second lower chamber.

26. A laboratory apparatus as claimed in claim 25 wherein said spin-activated siphon path comprises:
a generally vertical siphon channel disposed at an interior wall of said lower chamber, said generally vertically oriented siphon channel being open to said lower chamber at a lower end of said vertical siphon channel;
a generally horizontal siphon channel having a first end in fluid communication with said vertical siphon channel and a second end terminating proximate a central opening of said septum;
a spin-activated valve disposed proximate said second end of said horizontal siphon channel to control fluid flow between said second end and said central opening;
a further generally vertical siphon channel disposed through said septum to facilitate fluid communication between said generally horizontal siphon channel and said upper chamber.

27. A laboratory apparatus as claimed in claim 25 wherein said one or more valve mechanisms comprises:
a valve disposed to control the exit of fluids from said upper chamber to an area exterior said hollow rotor;
a spin-activated siphon path providing controlled fluid communication between said lower chamber and said upper chamber based on the speed at which said hollow rotor is rotated.

28. An apparatus for preparing a material for analysis comprising:
a hollow rotor mounted for rotation about a rotation axis;
a rotor motor adapted to rotate said hollow rotor;
a septum dividing said hollow rotor into an upper chamber and a lower chamber, said septum having a central opening;
a dam wall disposed in said upper chamber radially exterior to and circumventing said central opening;
a spin-activated valve mechanism disposed to control the exit of fluids from said upper chamber to an area exterior said hollow rotor;
a fluid collector disposed exterior to said hollow rotor and adapted to receive fluids exiting from said upper chamber through said spin-activated valve mechanism;
a spin-activated siphon path providing controlled fluid communication between said lower chamber and an area of said upper chamber radially exterior of said dam wall based on rotation rate of said hollow rotor;
said spin-activated valve mechanism and said spin-activated siphon path being activated at different rotation rates of said hollow rotor.

29. An apparatus as claimed in claim 28 wherein said septum defines a floor of said upper chamber that slants toward said dam wall.

30. An apparatus as claimed in claim 28 wherein said lower chamber comprises a floor that slants toward a central portion of said lower chamber.

31. An apparatus as claimed in claim 28 wherein siphon action of said spin-activated siphon path is controlled by a spin-activated valve.

32. An apparatus as claimed in claim 31 wherein said spin-activated valve of said siphon path opens at a lower rotation rate compared to said spin-activated valve of said upper chamber.

33. An apparatus as claimed in claim 31 wherein siphon action of said spin-activated siphon path discontinues at a lower rotation rate compared to the rotation rate at which said spin-activated valve of said upper chamber opens.

34. An apparatus as claimed in claim 28 and further comprising one or more sample preparation tools adapted to access at least one of said upper chamber and said lower chamber through an opening in said hollow rotor.

35. An apparatus as claimed in claim 34 wherein said one or more sample preparation tools comprises a tool selected from the group consisting of a homogenizer, a blender blade, a pipette probe, a mixer, an aspirator, a fluid dispenser, a hollow fiber filtration cartridge, and a dry reagent transfer device.

36. An apparatus as claimed in claim 34 wherein said opening is disposed through a top of said hollow rotor.

37. A sample preparation apparatus as claimed in claim 36 wherein said opening is generally annular in shape and concentric with said rotation axis of said hollow rotor.

38. An apparatus as claimed in claim 37 wherein at least a portion of said opening overlies an area of said upper chamber peripherally exterior to said dam wall.

39. An apparatus as claimed in claim 38 wherein said lower chamber includes a centrally disposed well in the floor thereof.

40. An apparatus as claimed in claim 39 wherein said centrally disposed well is adapted to receive a homogenizer.

41. An apparatus as claimed in claim 28 wherein said spin-activated siphon path comprises:
a generally vertical siphon channel disposed at an interior wall of said lower chamber, said generally vertically oriented siphon channel being open to said lower chamber at a lower end of said vertical siphon channel;
a generally horizontal siphon channel having a first end in fluid communication with said vertical siphon channel and a second end terminating proximate said central opening of said septum;
a spin-activated valve disposed proximate said second end of said horizontal siphon channel to control fluid flow between said second end and said central opening;
a further generally vertical siphon channel disposed through said septum to facilitate fluid communication between said generally horizontal siphon channel and said area of said upper chamber radially exterior said dam wall.
